(19) United States
(12) Patent Application Publication
(10) Pub. No.: US 2005/0257218 A1
(43) Pub. Date: Nov. 17, 2005

(54) Method for automatically downloading and installing driver of peripheral

(76) Inventor: Hong-Jih Lin, Hsintten City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/842,518

(22) Filed: May 11, 2004

(51) Int. Cl. G06F 9/445

(52) U.S. Cl. 717/178

(57) ABSTRACT

A method for automatically downloading and installing a driver of a peripheral is used on a computer connected with the Internet. First, a driver download IP address is stored in a peripheral to form a virtual driver. When a user installs or connects the peripheral to a computer, the virtual driver is automatically executed to connect to a website of the driver download IP address and download the driver of the peripheral via the computer. Finally, the driver is automatically installed. Thereby, the effect of plug-and-play of peripheral can be exactly accomplished for a user incapable of installing the driver. Moreover, the problem of a missing or damaged driver can be solved.

### FIELD OF THE INVENTION

The present invention relates to a method for automatically downloading and installing a driver of a peripheral and, more particularly, to a method whereby when installing a peripheral, a driver download IP address is provided in the peripheral so that the driver can be automatically downloaded and then installed by a computer connected to the Internet.

### BACKGROUND OF THE INVENTION

When one wants to use any peripheral on a computer, he first needs to connect the peripheral to the computer and install a driver or make relevant settings. The driver is generally provided by the manufacturer along with the peripheral.

For instance, when installing a printer on a computer, it is necessary to install a printer driver after the connection between the printer and the computer is made so that the computer can accurately control the printer. A user can store the driver after the installation is finished. Once a new operation system is installed on the computer or the peripheral is installed on another computer, it is necessary to reinstall the driver.

Drivers of common peripherals are generally stored on floppy disks or optical discs. If by any chance the floppy disk or optical disc can't be found or is damaged so that the drivers can't be accessed, the computer peripherals can't be used, hence resulting in much inconvenience.

Further, in consideration of the vigorous development of the Internet, almost all business or home computers have Internet access. Therefore, drivers of many peripherals or their updates and patches can be found on the Internet. Even if the driver of a peripheral is lost, one can still get it from the website of the manufacturer. However, not all users can download the driver from the Internet. Moreover, even if one has Internet access, he may not be able to find the correct driver. If one downloads a wrong driver carelessly, the result may be quite bad.

Accordingly, the present invention aims to propose a method for automatically downloading and installing a driver of a peripheral, whereby when installing a peripheral with a driver download IP address provided therein, a correct driver of the peripheral can be automatically downloaded from the Internet via a computer and then installed on the computer.

### SUMMARY OF THE INVENTION

An object of the present invention is to provide a method for automatically downloading and installing a driver of a peripheral, whereby when installing a peripheral with a driver download IP address provided therein, a correct driver of the peripheral can be automatically downloaded from the Internet via a computer and then installed on the computer.

To achieve the above object, the present invention provides a method for automatically downloading and installing a driver of a peripheral. First, a driver download IP address is stored in a peripheral to form a virtual driver. When a user installs or connects the peripheral to a computer, the virtual driver is automatically executed to connect to a website of the driver download an IP address and download the driver of the peripheral via the computer. Finally, the driver is automatically installed. Thereby, the effect of plug-and-play of peripheral can be exactly accomplished for a user incapable of installing the driver. Moreover, the problem of a missing or damaged driver can be solved.

### BRIEF DESCRIPTION OF THE DRAWINGS

The various objects and advantages of the present invention will be more readily understood from the following detailed description when read in conjunction with the appended drawings, in which:

FIG. 1 is an architectural diagram of the present invention; and

FIG. 2 is a flowchart of the present invention.

### DETAILED DESCRIPTION OF THE PREFERRED EMBODIMENTS

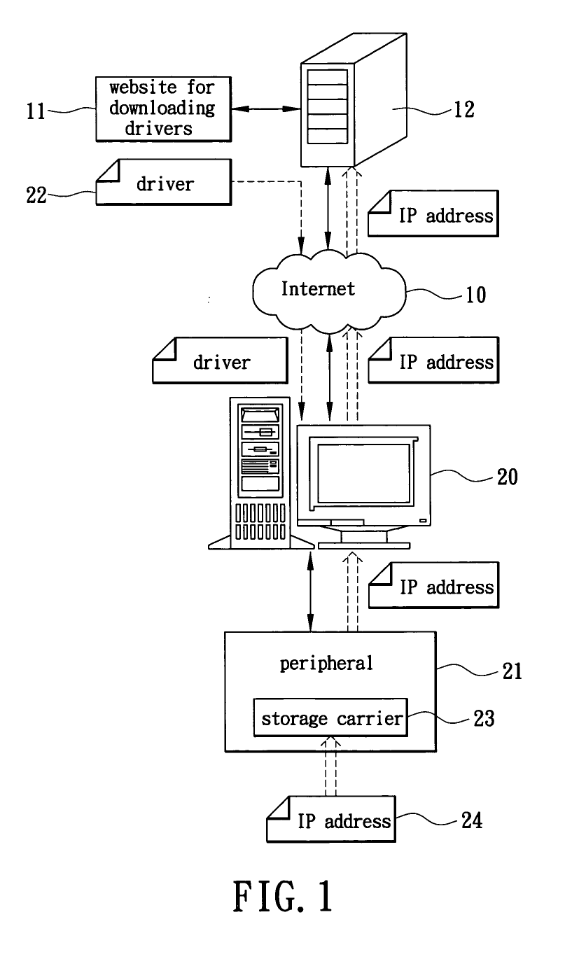

As shown in FIG. 1, the present invention proposes a method used on a computer 20 connected with the Internet 10. When installing or connecting a peripheral 21 onto the computer 20, a driver 22 is automatically downloaded from a driver download website 11. The driver download website 11 is a remote server 12 having a plurality of kinds of drivers 22 on the Internet. After the driver 22 is downloaded, the driver 22 is automatically installed so that the peripheral 21 can be used, hence accomplishing the object of plug-and-play.

In the present invention, a storage carrier 23 is disposed in the peripheral 21. The storage carrier 23 is a nonvolatile memory device like a popular flash memory, which can be used to read or write an IP address 24 of the driver download website 11. The capacity of the storage carrier 23 can be very small because the storage carrier 23 only needs to store the hypertext of the IP address 24 of the driver download website 11.

The peripheral 21 can have a plug-and-play interface like a USB interface. When a user installs or connects the peripheral 21 on the computer 20, the present invention will automatically detect the type and model of the peripheral 21 and the operation system of the computer 20 to facilitate connection to the driver download website 11 for downloading an appropriate driver 22.

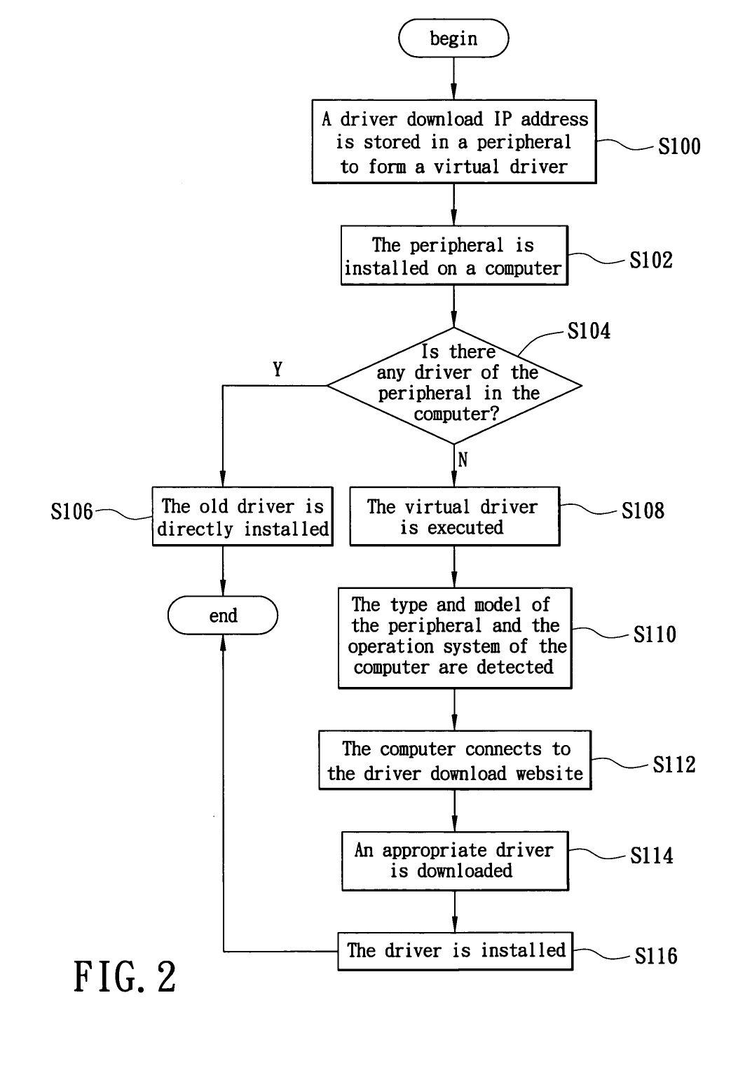

As shown in FIG. 2, the IP address 24 of the driver download website 11 is first stored in the peripheral 21 to form a virtual driver (Step S100). The virtual driver can be a batch file or an executable file for installation.

When a user installs or connects the peripheral 21 onto the computer (Step S102), the computer will automatically detect connection or installation of a new peripheral. The computer 20 will search the system to determine whether there is any driver for the peripheral 21 (Step S104). If there is already a driver 22, the computer will stop installing a new driver and directly install the old driver 22 (Step S106). If no driver is found, the virtual driver is automatically executed (Step 108). At this time, the computer 20 will detect the type and model of the peripheral 21 and the operation system of the computer 20 (Step S110). The computer 20 then generates a detection result and automatically connects to the driver download website 11 (Step S112). Next, the most appropriate driver 22 is downloaded to the computer 20 according to the detection result (Step 114).

The downloaded driver may be a compressed file composed of a plurality of files. Therefore, after the download is finished, it is necessary to decompress the driver. Finally, the driver is installed (Step S116) for use of the peripheral 21.

To sum up, the present invention has the following advantages:
1. It is no longer necessary for a user to install the driver of a peripheral himself, hence exactly accomplishing the object of plug-and-play.
2. The cost of the manufacturer can be lowered because it is no longer necessary to attach floppy disks or optical discs containing the driver of a peripheral along with the peripheral.
3. Even if the floppy disks or optical discs containing the driver are lost, one can still install the driver.
4. A correct driver can be automatically downloaded without causing a worse problem due to installation of a wrong driver.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A method for automatically downloading and installing a driver of a peripheral, said method being used on a computer connected to the Internet, said method comprising the steps of:
storing a driver download IP address in a peripheral to form a virtual driver;
installing or connecting said peripheral to a computer;
executing said virtual driver;
connecting to a website of said driver download IP address;
downloading a driver of said peripheral; and
installing said driver.

2. The method for automatically downloading and installing a driver of a peripheral as claimed in claim 1, wherein a storage carrier is disposed in said peripheral for storing said driver download IP address.

3. The method for automatically downloading and installing a driver of a peripheral as claimed in claim 2, wherein said storage carrier is a nonvolatile memory device, and the nonvolatile memory device is used to read or write said driver download IP address.

4. The method for automatically downloading and installing a driver of a peripheral as claimed in claim 1, wherein said peripheral has a plug-and-play interface.

5. The method for automatically downloading and installing a driver of a peripheral as claimed in claim 4, wherein said plug-and-play interface is a USB interface.

6. The method for automatically downloading and installing a driver of a peripheral as claimed in claim 1, further comprising the following steps after said step of installing or connecting said peripheral onto a computer:
said computer detecting whether said peripheral is installed or connected to the Internet;
searching for a driver of said peripheral in said computer;
stopping the step of executing said virtual driver and then installing the driver in said computer if the driver is found; and
performing the step of executing said driver if the driver is not found.

7. The method for automatically downloading and installing a driver of a peripheral as claimed in claim 1, wherein said virtual driver is a batch file.

8. The method for automatically downloading and installing a driver of a peripheral as claimed in claim 1, wherein said virtual driver is an executable file for installation.

9. The method for automatically downloading and installing a driver of a peripheral as claimed in claim 1, wherein said website of said driver download IP address is a remote server storing a plurality of drivers on the Internet.

10. The method for automatically downloading and installing a driver of a peripheral as claimed in claim 1, further comprising the following steps before the step of downloading a driver of said peripheral:
detecting a type and model of said peripheral;
detecting an operation system of said computer; and
selecting a most appropriate driver to be downloaded to said computer based on the type and model of said peripheral and the operation system of said computer.

11. The method for automatically downloading and installing a driver of a peripheral as claimed in claim 1, wherein said driver on said website is a compressed file composed of a plurality of files, and said method further comprises the step of decompressing said driver after the step of downloading a driver of said peripheral.
